(19) United States
(12) Patent Application Publication
(10) Pub. No.: US 2025/0216495 A1
(43) Pub. Date: Jul. 3, 2025

(54) RECEIVER COMPRISING ADJUSTABLE ANTENNA FOR ANGLE OF ARRIVAL ESTIMATION OF INPUT SIGNALS

(71) Applicant: HUAWEI TECHNOLOGIES CO., LTD., Shenzhen (CN)

(72) Inventors: Ramin Khayatzadeh, Boulogne Billancourt (FR); Mohamed Kamoun, Boulogne Billancourt (FR)

(73) Assignee: HUAWEI TECHNOLOGIES CO., LTD., Shenzhen (CN)

(21) Appl. No.: 19/080,622

(22) Filed: Mar. 14, 2025

Related U.S. Application Data
(63) Continuation of application No. PCT/EP2022/075559, filed on Sep. 14, 2022.

(51) Int. Cl. G01S 3/38; G01S 3/04; H01Q 15/02; H01Q 21/00

(52) U.S. Cl. CPC G01S 3/38; G01S 3/043; H01Q 15/02; H01Q 21/00

(57) ABSTRACT

The disclosure relates to angle of arrival estimation of one or more input signals. The disclosure proposes a receiver and a corresponding method for operating the receiver. The receiver comprises one or more antennas, wherein each antenna is covered by a material with a controllable permittivity and/or permeability. The receiver comprises a controller configured to generate with each antenna a plurality of consecutive measurements of the one or more input signals, in order to generate one or more pluralities of consecutive measurements, adjust, for each antenna of the one or more antennas, the controllable material between at least two consecutive measurements of the plurality of consecutive measurements generated with the antenna, and estimate the one or more angles of arrival of the one or more input signals based on the one or more pluralities of consecutive measurements.

### CROSS-REFERENCE TO RELATED APPLICATIONS

This application is a continuation of International Application No. PCT/EP2022/075559, filed on Sep. 14, 2022, the disclosure of which is hereby incorporated by reference in its entirety.

### TECHNICAL FIELD

This disclosure relates to angle of arrival (AoA) estimation for one or more input signals. The disclosure proposes a receiver and a corresponding method for operating the receiver, wherein the receiver comprises one or more antennas covered by a controllable material.

### BACKGROUND

Conventionally, measuring the AoA of a signal is performed by using an array of antennas. Conventional solutions are, for example, based on high-resolution AoA algorithms and multiple-antenna technology comprising, for example, an array of equally spaced antennas. The majority of angle estimation techniques are based on measuring the phase difference of a signal received at different antennas.

However, to avoid ambiguity between multiple sources, the number of antennas needs to exceed the number of sources to be detected, and consequently many radio frequency (RF) chains are required. Thus, conventional devices for AoA estimation can be bulky or complex for small devices.

### SUMMARY

In view of the above, this disclosure aims to provide a smaller, more compact, and/or more efficient receiver for AoA estimation of one or more input signals.

This is achieved by the solutions of this disclosure as described in the independent claims. Advantageous implementations are defined in the dependent claims.

A first aspect of this disclosure provides a receiver for estimating one or more angles of arrival of respectively one or more input signals, the receiver comprising: one or more antennas, wherein each antenna is covered by a material with a controllable permittivity and/or permeability; and a controller configured to: generate, with each antenna of the one or more antennas, a plurality of consecutive measurements of the one or more input signals, in order to generate one or more pluralities of consecutive measurements; adjust, for each antenna of the one or more antennas, the controllable material between at least two consecutive measurements of the plurality of consecutive measurements generated with the antenna; and estimate the one or more angles of arrival of the one or more input signals based on the one or more pluralities of consecutive measurements.

The receiver of the first aspect may be smaller, more compact, and/or more efficient than a conventional receiver, since the number of antennas required for the AoA estimation of one or more input signals is smaller than in the conventional receiver. The one or more input signals may be electromagnetic waves. This is achieved, because of the controllable material and the adjustment of the controllable material between the consecutive measurements.

For example, the controller may be configured to adjust, for each antenna of the one or more antennas, the controllable material between at least two directly consecutive measurements. Additionally or alternatively, the controller may be configured to adjust the controllable material between every measurement of the plurality of consecutive measurements generated with said antenna. Thus, every measurement generated with the one or more antennas may be based on a different setting of the controllable material.

The receiver may be configured to separately or jointly adjust, for each antenna of the one or more antennas, the controllable material covering the antenna. The controller may control the one or more antennas and the one or more controllable materials.

Each antenna of the one or more antennas may be covered by a same material with controllable permittivity and/or permeability. Alternatively, some antennas of the one or more antennas may be covered by a different material with a controllable permittivity and/or permeability.

In a further implementation form of the first aspect, the controller is configured to adjust, for each antenna of the one or more antennas, a refractive index of the controllable material between at least two consecutive measurements of the plurality of measurements generated with the antenna.

The refractive index may be always adjusted to a different and/or a predetermined refractive index.

In a further implementation form of the first aspect, the one or more antennas are configured to form an antenna array, and/or the receiver further comprises one or more additional antennas, and wherein the one or more antennas and the one or more additional antennas are configured to form an antenna array.

Each antenna of the antenna array may be equally spaced from each other.

In a further implementation form of the first aspect, the controller is configured to generate each measurement of the one or more pluralities of consecutive measurements at a measurement time of a plurality of measurement times, and/or adjust, for each antenna of the one or more antennas, the controllable material between each measurement time of the plurality of measurement times.

In a further implementation form of the first aspect, the receiver further comprises a memory, and wherein, for each measurement of the one or more pluralities of consecutive measurements, the memory is configured to: store the measurement, and store a refractive index value of the controllable material with which the measurement is generated.

The controller may be configured to measure a refractive index value of a controllable material covering each of the one or more antennas. For example, during, before, or after each measurement of the one or more pluralities of consecutive measurements, the controller may measure the refractive index covering at least one of the one or more antennas in order to determine at least one refractive index value. The controller may measure a refractive index by controlling specialized hardware, for example, an optical device.

Alternatively or additionally, one or more refractive index values of each controllable material covering each of the one or more antennas may be predetermined.

Alternatively to a refractive index value, the controller may be configured to store a permittivity and/or permeability value of the controllable material with which the measurement is generated.

One or more permittivity and/or permeability values of each controllable material covering each of the one or more antennas may be predetermined or measured.

In a further implementation form of the first aspect, the controller is configured to estimate the one or more angles of arrival of the one or more input signals based on a plurality of stored refractive index values and measurements.

Each measurement of the plurality of stored measurements may correspond to one of the stored refractive index values of the plurality of stored refractive index values with which the measurement was generated.

Alternatively, the controller may be configured to estimate the one or more angles of arrival of the one or more input signals based on a plurality of stored permittivity and/or permeability values and measurements.

Each measurement of the plurality of stored measurements may correspond to one of the stored permittivity and/or permeability values of the plurality of stored permittivity and/or permeability values with which the measurement was generated.

In a further implementation form of the first aspect, each measurement of the one or more pluralities of consecutive measurements comprises a phase measurement of the one or more input signals.

Each measurement of the one or more pluralities of consecutive measurements may consist of a phase measurement of the one or more input signals.

In a further implementation form of the first aspect, the controller is configured to calculate at least one phase difference based on at least two phase measurements, or based on at least one phase measurement and a predetermined reference phase.

The predetermined reference phase may be communicated through dedicated signaling or estimated using a synchronization training sequence.

Each phase difference may be based on phase measurements generated with a same antenna.

Alternatively, at least one phase difference may be based on phase measurements generated with a same antenna, and/or one or more other phase differences may be based on phase measurements generated with different antennas, for example, with different conventional antennas.

In a further implementation form of the first aspect, the controller is configured to estimate the one or more angles of arrival of the one or more input signals based further on the at least one phase difference.

In a further implementation form of the first aspect, the controller is configured to estimate the one or more angles of arrival of the one or more input signals based further on the at least one phase difference and the corresponding stored refractive index value of each measurement of the one or more pluralities of consecutive measurements used for calculating the at least one phase difference.

Alternatively, the controller may be configured to estimate the one or more angles of arrival of the one or more input signals based further on the at least one phase difference and the corresponding stored permittivity and/or permeability value of each measurement of the one or more pluralities of consecutive measurements used for calculating the at least one phase difference.

In a further implementation form of the first aspect, each plurality of consecutive measurements of the one or more pluralities of consecutive measurements comprises three or more consecutive measurements, wherein the at least one phase difference comprises at least two phase differences, and wherein the controller is configured to: calculate, for each of the one or more input signals, a ratio of two phase differences of the at least two phase differences to form one or more ratios of phase differences, and estimate the one or more angles of arrival of the one or more input signals based further on the one or more ratios of phase differences.

In a further implementation form of the first aspect, the controller is configured to calculate the two phase differences of each ratio of the one or more ratios of phase differences based on at least one different phase measurement.

$$R ( {τ}_{0} , {τ}_{1} , {τ}_{2} ) = \frac{Δ Φ ( {τ}_{2} , {τ}_{0} )}{Δ Φ ( {τ}_{1} , {τ}_{0} )} = \frac{( \sqrt{{( \frac{{n}_{t} ( {τ}_{2} )}{{n}_{i}} )}^{2} - {sin ( {θ}_{i} )}^{2}} - \sqrt{{( \frac{{n}_{t} ( {τ}_{0} )}{{n}_{i}} )}^{2} - {sin ( {θ}_{i} )}^{2} )}}{\sqrt{{( \frac{{n}_{t} ( {τ}_{1} )}{{n}_{i}} )}^{2} - {sin ( {θ}_{i} )}^{2}} - \sqrt{{( \frac{{n}_{t} ( {τ}_{0} )}{{n}_{i}} )}^{2} - {sin ( {θ}_{i} )}^{2} )}} \qquad ( 5 )$$

For example, the two phase differences of each ratio of the one or more ratios of phase differences have different values.

In a further implementation form of the first aspect, the controller is configured to estimate the one or more angles of arrival of the one or more input signals based further on a thickness of the controllable material covering each antenna of the one or more antennas and a norm of a wave vector of each of the one or more input signals.

A norm of a wave vector of each of the one or more input signals may be measured and/or predetermined.

In a further implementation form of the first aspect, the controller is configured to estimate the one or more angles of arrival of the one or more input signals based further on a refractive index of an ambient material.

The ambient material may be an external medium external to the one or more antennas and controllable materials. The refractive index of an ambient material may be predetermined, and/or estimated as an absolute value or a relative value to a predefined state of the material covering the antenna.

In a further implementation form of the first aspect, the controller is configured to: average a plurality of measurements to form one or more averaged measurements, and estimate the one or more angles of arrival of the one or more input signals based further on the one or more averaged measurements.

Thus, the noise included in measurements may be reduced.

In a further implementation form of the first aspect, the controller is configured to estimate the one or more angles of arrival of the one or more input signals based further on a predetermined lookup table comprising at least one of differential phases and ratios of differential phases.

The lookup table may be determined based on at least one of: a refractive index of an ambient material, a refractive index of each controllable material for each measurement, a thickness of each controllable material, an absolute value of a wave vector of each of the one or more input signals.

The controller may be configured store one or more lookup tables, wherein each lookup table may be determined based on different values of the corresponding parameters.

In a further implementation form of the first aspect, the number of measurements of the one or more pluralities of consecutive measurements is larger than the number of the one or more input signals.

The number of measurements generated with conventional antennas combined with the number of measurements of the one or more pluralities of consecutive measurements may be larger than the number of one or more input signals. The number of measurements of the one or more pluralities of consecutive measurements, for example the number of measurements of the one or more antennas, may be smaller than the number of the one or more input signals.

In a further implementation form of the first aspect, each antenna of the one or more antennas is covered with the same controllable material of a same thickness, or wherein at least two antennas of the one or more antennas are covered with at least one of a different controllable material and a controllable material of different thickness.

Thus, the receiver may be simplified.

In a further implementation form of the first aspect, the controller is configured to estimate the one or more angles of arrival of the one or more input signals by using at least one of a Multiple Signal Classification (MUSIC) algorithm, an estimation of signal parameters via rotational invariant techniques (ESPRIT) algorithm, and a super-resolution algorithm for an uniform linear and temporal array (ULTA).

In a further implementation form of the first aspect, the controller is configured to: generate an overall matrix of steering vectors, the overall matrix of steering vectors comprising a matrix of steering vectors for each input signal of the one or more input signals, the matrix of steering vectors comprising a steering vector for each measurement of the corresponding input signal, and estimate the one or more angles of arrival of the one or more input signals based further on at least one of the overall matrix of steering vectors and multiplying the overall matrix of steering vectors with a matrix of input signals of the one more input signals.

The phrase “each measurement” may refer in this disclosure to each measurement of the one or more pluralities of consecutive measurements and/or may refer to each measurement generated with the one or more additional and/or conventional antennas.

One or more additional measurements generated with one or more additional and/or conventional antennas may be added to the one or more pluralities of consecutive measurements. Thus, the total number of measurements may be increased.

Each steering vector may be based on the corresponding refractive index value for each measurement of the corresponding input signal.

Alternatively, each steering vector may be based on the corresponding permittivity and/or permeability value for each measurement of the corresponding input signal.

The controller may be configured to estimate the one or more angles of arrival of the one or more input signals by using at least one of a MUSIC algorithm, ESPRIT algorithm, and a super-resolution algorithm for an ULTA based on the overall matrix of steering vectors.

In a further implementation form of the first aspect, the temporal changes of all parameters of the one or more input signals during the generation of all measurements of the one or more pluralities of consecutive measurements are negligible, for example, one or more orders of magnitude smaller than the corresponding parameters of the one or more input signals.

The one or more input signals may not change during the generation of the one or more pluralities of consecutive measurements.

A second aspect of this disclosure provides a method of operating a receiver for estimating one or more angles of arrival of respectively one or more input signals, the receiver comprising one or more antennas, wherein each antenna is covered by a material with a controllable permittivity and/or permeability, and a controller, wherein the method comprises: generating, by the controller, with each antenna of the one or more antennas, a plurality of consecutive measurements of the one or more input signals, in order to generate one or more pluralities of consecutive measurements; adjusting, by the controller, for each antenna of the one or more antennas, the controllable material between at least two consecutive measurements of the plurality of consecutive measurements generated with the antenna; and estimating, by the controller, the one or more angles of arrival of the one or more input signals based on the one or more pluralities of consecutive measurements.

The method of the second aspect may have implementation forms that correspond to the implementation forms of the device of the first aspect. The method of the second aspect and its implementation forms achieve the advantages and effects described above for the device of the first aspect and its respective implementation forms.

A third aspect of this disclosure provides a computer program product comprising a program code for performing, when the program code is executed on a computer, the method according to the second aspect.

Further, in this disclosure the phrase “conventional antenna” may refer to a conventional antenna not covered by a material with a controllable permittivity and/or permeability.

Further, in this disclosure the phrase “phase measurement” and “measured phase” may be used interchangeably.

Further, in this disclosure each measurement may consist of a phase measurement and/or each phase measurement may consist of a measured phase.

Further, in this disclosure the phrase “controllable material” and “variable material” may be used interchangeably.

It is to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of embodiments in relation to the enclosed drawings, in which

FIG. 1 shows a device according to an embodiment of this disclosure.

FIG. 2 shows an exemplary antenna array.

FIG. 3 shows an antenna covered by a material with a controllable permittivity and/or permeability according to an embodiment of this disclosure.

FIG. 4 shows measurements according to an embodiment of this disclosure.

FIG. 5a shows a graph relating a differential metric to an angle of arrival according to an embodiment of this disclosure.

FIG. 5b shows a graph relating a ratio of differential metrics to an angle of arrival according to an embodiment of this disclosure.

FIG. 6 shows a MUSIC spectrum based on a TA according to an embodiment of this disclosure.

FIG. 7 shows three antennas covered by a material with a controllable permittivity and/or permeability according to an embodiment of this disclosure.

FIG. 8 shows a MUSIC spectrum based on a ULTA according to an embodiment of this disclosure.

FIG. 9 shows three MUSIC spectra based on a ULA, a TA and a ULTA according to an embodiment of this disclosure.

FIG. 10 shows a method according to an embodiment of this disclosure.

### DETAILED DESCRIPTION OF EMBODIMENTS

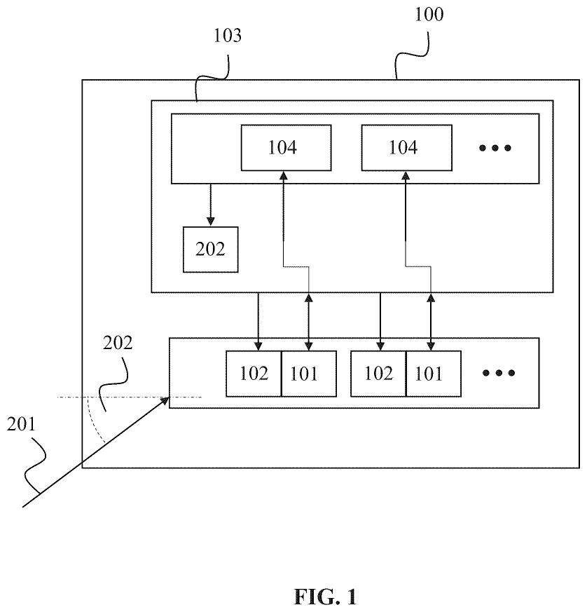

FIG. 1 shows a receiver 100 according to an embodiment of this disclosure. The receiver 100 comprises one or more antennas 101 and a controller 103, wherein each antenna 101 of the one or more antennas 101 is covered by a material 102 with a controllable permittivity and/or permeability. Further, FIG. 1 shows the one or more antennas 101 receiving one or more input signals 201 at one or more angles of arrival 202. The controller 103 is configured to generate, with each antenna 101 of the one or more antennas 101, a plurality of consecutive measurements 104 of the one or more input signals, in order to generate one or more pluralities of consecutive measurements 104, wherein the controller 103 is configured to adjust, for each antenna 101a of the one or more antennas 101, the controllable material 102 between at least two consecutive measurements of the plurality of consecutive measurements 104 generated with the antenna 101. Further, the controller 103 is configured to estimate the one or more angles of arrival 202 of the one or more input signals 201 based on the one or more pluralities of consecutive measurements 104.

For example, each plurality of consecutive measurements 104 comprises at least two measurements that were generated with different states of the controllable material 102 covering the antenna, with which the measurements were generated. Changing a state of the controllable material 102 between measurements may lead to detectable phase differences of the one or more input signals 201 between measurements.

Estimating one or more AoA 202 with the receiver 100 may be based on an array of temporal measurements of the phases of the one or more input signals 201, which may replace spatial measurements and may reduce the complexity and bulkiness compared to multi-antenna receivers 100. Spatial antenna arrays may be replaced with temporal arrays. Temporal arrays may be based on generating consecutive measurements 104 in time of the one or more input signals 201 that differ from each other. The consecutive measurements 104 may differ from each other due to changes of the controllable materials 102 covering the one or more antennas during the measurements.

The receiver 100 may reduce the complexity of the receiver (RX) side by removing antennas and thus RF chains, which are generally required for antennas. An antenna array comprising two or more antennas may be replaced with, for example, a single tunable antenna. Conventionally, in order to measure an angle of arrival, equally spaced antennas forming an antenna array are placed at the RX side, and two or more phase measurements are performed to determine at least one phase difference between these antennas. The measured phase difference is used to estimate the angle of arrival of the received signal.

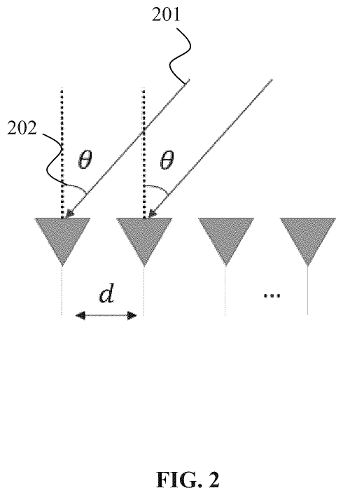

FIG. 2 shows an example of an array of antennas which is used to detect the angle of arrival 202 of a single source generating an input signal 201 by relating the phase difference between two antenna elements to the angle of arrival 202 according to the following equation:

$$Δφ = \frac{2 π}{λ} d sin ( θ ) \qquad ( 1 )$$

Where d is the distance between the antennas of the array, λ is the wavelength of the signal, Δφ is the phase difference between the two adjacent antennas, and θ is the angle of arrival 202. For example, the angle of arrival 202 can be determined based on the phase difference between the two adjacent antennas.

In another example, many sources are emitting towards the RX side. An array of antennas with a higher number of antennas than the number of sources may be required. The received signals can be formulated as follows:

$$[ \begin{matrix}{x}_{1}^{T} ( t ) \\ ⋮ \\ {x}_{M}^{T} ( t )\end{matrix} ] = [ a ( {θ}_{1} ) … a ( {θ}_{N} ) ] [ \begin{matrix}{s}_{1}^{T} ( t ) \\ ⋮ \\ {s}_{N}^{T} ( t )\end{matrix} ] + [ \begin{matrix}{n}_{1}^{T} ( t ) \\ ⋮ \\ {n}_{M}^{T} ( t )\end{matrix} ] \\ X = A S + Z \qquad ( 2 )$$

Where X is a M×N matrix containing the received signals at the RX side, M is the number of antennas, N is the number of sources, S is the matrix of source signals or input signals, Z is the matrix of noise, which may be assumed to be a white Gaussian noise, and A is a matrix of steering vectors a(θ). Using this formulation, the AoA 202 can be estimated using conventional algorithms, for example, MUSIC or ESPRIT.

As can be seen from Eq. 2, the number of M equations (antennas) should be higher than the number of variables (sources) N. In a conventional example, M antennas and M RF chains are required to detect and measure a number N<M of different angles of arrival.

The receiver 100 allows to define a new type of steering vector (A) based on time domain measurements of the one or more antennas 101. The time domain measurements may be considered a virtual array of antennas spaced from each other in time rather than space. According to Eq. 2, the receiver 100 may be required to create enough equations for the unknowns of Eq. 2, for example, by increasing the number consecutive measurements. The temporal measurements may be required to be conducted fast enough, for example, faster than the coherence time of the channel, and with different settings of the controllable material 102 covering the antennas.

The same conventional algorithms (MUSIC, ESPRIT, etc.) may be applied for the receiver 100 to find the angles of arrival 202 from different sources. The receiver 100 relies on the use of a controllable material 102 with, for example, a controllable refractive index which is placed on the one or more antennas 101. At each measurement time, the refractive index may be changed to a new but known value.

A low-complexity example of the receiver 100 for AoA 202 estimation or sensing and localization of sources may comprise only one antenna 101a. The receiver 100 may comprise a single antenna structure which may enable tenability. The antenna structure may comprise the one antenna 101a and a variable dielectric material 102, for example a ferroelectric material 102, covering the antenna. The antenna structure provides the capability to change the AoA 202 of the incident waves inside the antenna structure and creates a matrix of measurements according to Eq. 2 with which the AoA 202 may be determined.

In summary, the matrix of steering vectors A in Eq. 2 may be constructed from measurements performed with known angles of arrival, or by using a relation modelling different states of the tunable material 102 that covers the antenna. S can be determined from Eq. 2 based on A, X, and Z. Various angle estimation techniques, for example, super-resolution can be adapted to infer one or more angles from a series of consecutive measurements.

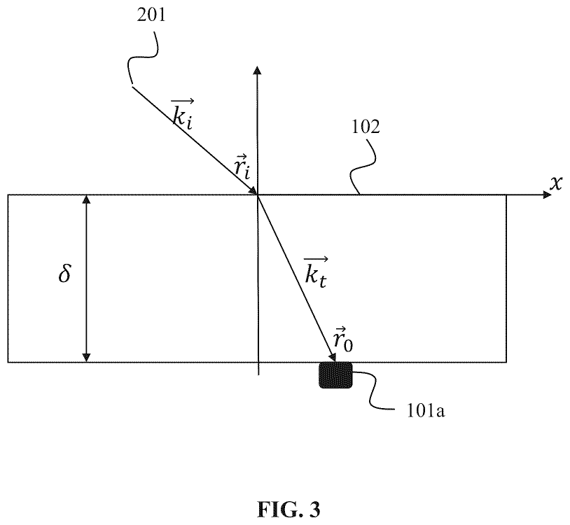

FIG. 3 shows a single antenna 101a covered with a controllable material 102 receiving an input single 201.

In the following example of FIG. 3, the electric field of an incidence plane wave is given by:

$$\vec{{E}_{ι}} = {E}_{0} exp ( j 2 π \vec{{k}_{ι}} \vec{r} )$$

Where \vec{r} is a location of the observation point. As a simplification, a bi-dimensional problem in the (x, z) plane is considered. The antenna 101a is covered with a controllable material 102 for which the refractive index can be changed. The refractive index of the ambient material is denoted nᵢ and the refractive index of the controllable material 102 is denoted nₜ. The antenna location is denoted

$${\vec{r}}_{0} = δ [ \begin{matrix}0 \\ 0 \\ - 1\end{matrix} ] ,$$

the incident wave that is received by the antenna 101a hits the controllable material 102 at location

$${\vec{r}}_{i} = δ [ \begin{matrix}- tan ( {θ}_{t} ) \\ 0 \\ 0\end{matrix} ] ,$$

where θₜ is the angle with respect to the z axis and δ is the thickness of the controllable material 102 covering the antenna 101a. Based on the dispersion equations: phase matching, conservation of frequency and change of wave velocity, the phase of the refracted wave propagating inside the controllable material 102 may be given by:

$$Φ ( {\vec{r}}_{0} ) = \vec{{k}_{t}} \cdot ( {\vec{r}}_{0} - {\vec{r}}_{i} ) + {\vec{k}}_{i} {\vec{r}}_{i}$$

Where \vec{k}ₜ is the wave vector of the refracted wave. The phase depends on the value of the refractive index of the controllable material 102 covering the antenna 101a located in \vec{r}₀. The phase of the wave impinging on the antenna 101a may be written as a function of the refractive index of the controllable material 102 as well as the angle of arrival 202 of the wave impinging on the material 102.

$$Φ ( {\vec{r}}_{0} ) = \vec{{k}_{t}} \cdot ( {\vec{r}}_{0} - {\vec{r}}_{i} ) + {\vec{k}}_{i} {\vec{r}}_{i} \\ Φ ( {\vec{r}}_{0} ) = \frac{{k}_{t} δ}{cos ( {θ}_{t} )} - {k}_{i} sin ( {θ}_{i} ) tan ( {θ}_{t} ) = \frac{{k}_{i} {n}_{t}}{{n}_{i}} \frac{δ}{cos ( {θ}_{t} )} - \frac{{k}_{i} δ \frac{{n}_{i}}{{n}_{t}} sin {( {θ}_{i} )}^{2}}{\sqrt{1 - sin {( {θ}_{i} )}^{2}}} = {k}_{i} δ \frac{{n}_{t}}{{n}_{i}} \frac{1}{\sqrt{1 - {( \frac{{n}_{i}}{{n}_{t}} )}^{2} {sin ( {θ}_{i} )}^{2}}} - \frac{{k}_{i} δ \frac{{n}_{i}}{{n}_{t}} sin {( {θ}_{i} )}^{2}}{\sqrt{1 - {( \frac{{n}_{i}}{{n}_{t}} )}^{2} {sin ( {θ}_{i} )}^{2}}}$$

Thus, the phase may be simplified to:

$$Φ ( {\vec{r}}_{0} ) = {k}_{i} δ \sqrt{{( \frac{{n}_{t}}{{n}_{i}} )}^{2} - {sin ( {θ}_{i} )}^{2}} \qquad ( 3 )$$

The phase Φ(\vec{r}₀) may be considered a function of the incident angle, and the current value of the refractive index nₜ of the material 102 covering the antenna 101a.

As a phase is relative, a differential approach may be required to estimate the angle θᵢ for a single source estimation. For the estimation of the AoA 202 in a multi-source scenario, super-resolution methods may be required.

When a temporal array of antennas is used, for example, by adjusting the controllable material 102 covering one or more antennas 101 between consecutive measurements, the AoA 202 estimation may be based on determining a phase of a wave received by an antenna at different times corresponding to different states of the controllable material 102 covering the antenna.

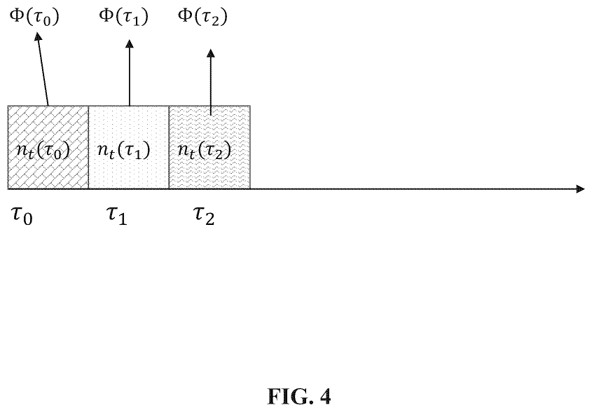

FIG. 4 shows an example for consecutive phase measurements generated with an antenna 101a and corresponding refractive index values nₜ(τᵢ). The phases Φ(τᵢ) refer to the phase of a signal received at time τᵢ, and the refractive index values nₜ(τᵢ) refer to the refractive index values at time τᵢ of a controllable material 102 covering the antenna with which the measurements are generated. The determined phases Φ(τᵢ) may be combined with an averaging procedure either in the signal domain:

$$Φ ( {τ}_{i} ) = ∠ ( {\sum }_{k} {y}_{i} ( k ) )$$

or in the phase domain:

$$Φ ( {τ}_{i} ) = ( \frac{1}{N} {\sum }_{k} ∠ ( {y}_{i} ( k ) ) )$$

Where N is the number of signal measurements performed during a time slot τᵢ. In this example, the initial phase of the signals is required to be common or known to ensure consistency.

Additionally or alternatively, the refractive index values nₜ(τᵢ) may be combined with an averaging procedure either in the signal domain or in the phase domain. The refractive index values nₜ(τᵢ) may be predetermined or measured.

A direction of arrival or angle of arrival 202 estimation of one or more input signals 201 with one or more antennas 101, for example a single antenna, may be based on a phase difference approach.

When assuming a single source generating one input signal 201 or input wave, the relation between an angle of arrival 202 of the input signal and the phase of the wave received by the antenna is given by Eq. 3. An absolute phase may not be obtainable without a reference phase, which is, for example, communicated through dedicated signalling. A differential approach may provide an alternative for AoA 202 estimation without requiring a reference phase and may include:
At time τ₀ set nₜ to nₜ(τ₀)
At time τ₁ set nₜ to nₜ(τ₁)
Computing a difference of the phases of the signals observed at time τ₀ and τ₁, which may lead to the following equation:

$$Δ Φ ( {τ}_{0} , {τ}_{1} ) = {k}_{i} δ ( \sqrt{{( \frac{{n}_{t} ( {τ}_{1} )}{{n}_{i}} )}^{2} - {sin ( {θ}_{i} )}^{2}} - \sqrt{{( \frac{{n}_{t} ( {τ}_{0} )}{{n}_{i}} )}^{2} - {sin ( {θ}_{i} )}^{2} )} \qquad ( 4 )$$

Based on the differential approach, the absolute value of the angle of arrival of the input signal can be estimated. The angle of arrival may be defined with respect to a direction normal to the surface of the controllable material 102. The AoA may range between

$$[ 0 \frac{π}{2} ] .$$

Thus, based on |sin(θᵢ)| the angles θᵢ may be estimated.

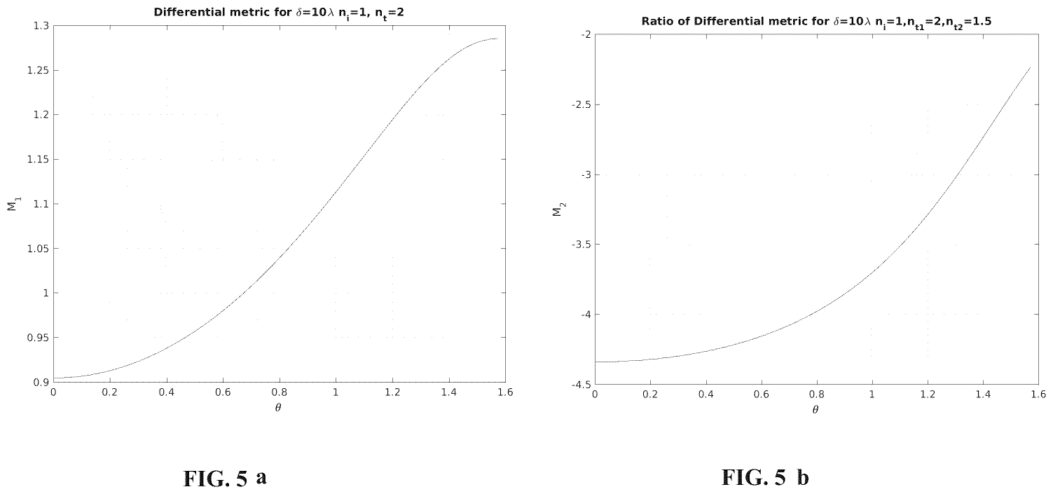

FIG. 5a shows an example of the relation between the differential metric M₁=ΔΦ(t₀, t₁) and the angle of arrival θ ranging between

$$[ 0 \frac{π}{2} ] ,$$

where δ=10λ, nᵢ=1, and nₜ=2. The differential metric is proportional to kᵢδ, which may be required to be predetermined.

This requirement may be removed by, for example, using a ratio of two differential metrics calculated with three measurements in three time slots: τ₀, τ₁, τ₂ based on the following:

$$R ( {τ}_{0} , {τ}_{1} , {τ}_{2} ) = \frac{Δ Φ ( {τ}_{2} , {τ}_{0} )}{Δ Φ ( {τ}_{1} , {τ}_{0} )} = \frac{( \sqrt{{( \frac{{n}_{t} ( {τ}_{2} )}{{n}_{i}} )}^{2} - {sin ( {θ}_{i} )}^{2}} - \sqrt{{( \frac{{n}_{t} ( {τ}_{0} )}{{n}_{i}} )}^{2} - {sin ( {θ}_{i} )}^{2} )}}{\sqrt{{( \frac{{n}_{t} ( {τ}_{1} )}{{n}_{i}} )}^{2} - {sin ( {θ}_{i} )}^{2}} - \sqrt{{( \frac{{n}_{t} ( {τ}_{0} )}{{n}_{i}} )}^{2} - {sin ( {θ}_{i} )}^{2}}} \qquad ( 5 )$$

Several combinations in the ratio computation may be considered. Eq. 5 corresponds to the combination (2, 0) and (1, 0).

FIG. 5b shows an example of the relation between a ratio of differential metric M₂=R (τ₀, τ₁, τ₂) and the angle of arrival θ ranging between

$$[ 0 \frac{π}{2} ] ,$$

where δ=10λ, nᵢ=1, nₜ₁=2, and nₜ₂=1.5.

FIG. 5a shows an example of a differential metric for AoA 202 estimation and FIG. 5b shows an example of a ratio of differential metric for AoA 202 estimation. The term sin(θᵢ)² may be estimated based on FIG. 5a or FIG. 5b, conventional estimation or function inversion techniques (zero forcing, mmse, maximum likelihood, etc.), and R (τ₀, τ₁, τ₂) or ΔΦ(τ₀, τ₁), which are determined based on phase measurements. Thus, θᵢ can be determined in the range

$$[ 0 \frac{π}{2} ] .$$

For example, a look-up table based on FIG. 5a or FIG. 5b may be created for determining θᵢ.

FIGS. 5a and 5b only show an example for specific parameters of Eq. 4 and Eq. 5, and are based on, for example, the values of nₜ(τᵢ) at the different times τᵢ.

An example of a procedure to perform AoA 202 estimation is as follows:
Compute a differential metric ΔΦ(τ₀, τ₁) or a ratio of differential metric R(τ₀, τ₁, τ₂).
Conduct optional noise removal by averaging over multiple measurements.
Recover the corresponding angle θᵢ using one of the corresponding pre-calculated curves or look-up tables, for example as shown in FIG. 5a or 5b.

A MUSIC super-resolution algorithm may be used for single source or multi-source signals. Super-resolution algorithms may be employed to recover the angle of arrival 202 after a series of measurements with a temporal array (TA) antenna. Estimating one or more angles of arrival 202 may comprise:
1. Estimate an upper bound on the number of angles of arrival 202 or make an assumption on this upper bound denoted M.
2. Compute a series of N temporal array measurements, each measurement including K refractive states, where K>M, wherein the n^{th} measurement is denoted sₙ(nₜ(τ₀)) . . . sₙ(nₜ(τ_{K-1})).
3. Build the matrix S of size K×N, where S_{n,k}=sₙ(τₖ) K>M with a common phase reference, let denote s₀ . . . s_{K-1}.
4. Compute the full singular value decomposition of the matrix S=Σₗ₌₁^{l=K}λₗuₗvₗ^{H} where uₗ and vₗ are the left and right singular vectors corresponding to eigenvalue λₗ, λₗ are sorted in decreasing magnitude order.
5. Estimate the null space of the matrix S corresponding to the L least magnitude singular values, L being the size of this space, and build the matrix Λ_{L}=[v_{K-N+1} . . . v_{N}].
6. Generate the MUSIC spectrum Ψ(θ) according to Eq. 6.
7. Estimate the relevant peaks in the MUSIC spectrum Ψ(θ) and output the corresponding values of θ, denoted θ₁ . . . θ_{L}.

$$Ψ ( θ ) = \frac{1}{{a ( θ )}^{H} {Λ}_{L} a ( θ )} \qquad ( 6 )$$

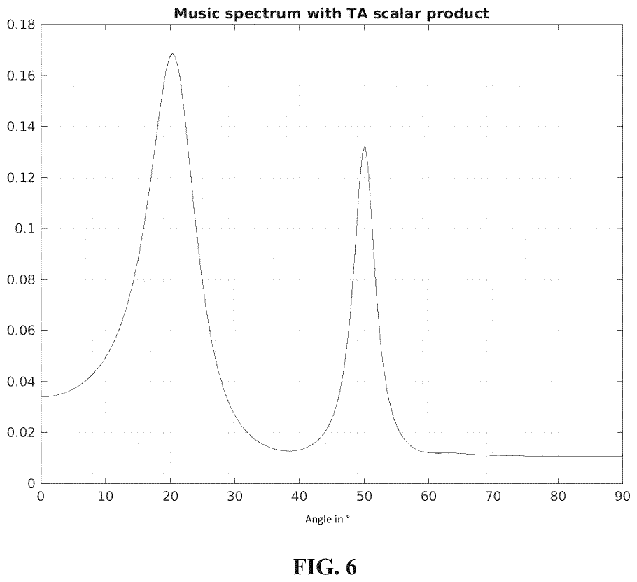

FIG. 6 shows an exemplary MUSIC spectrum based on a TA and according to Eq. 6.

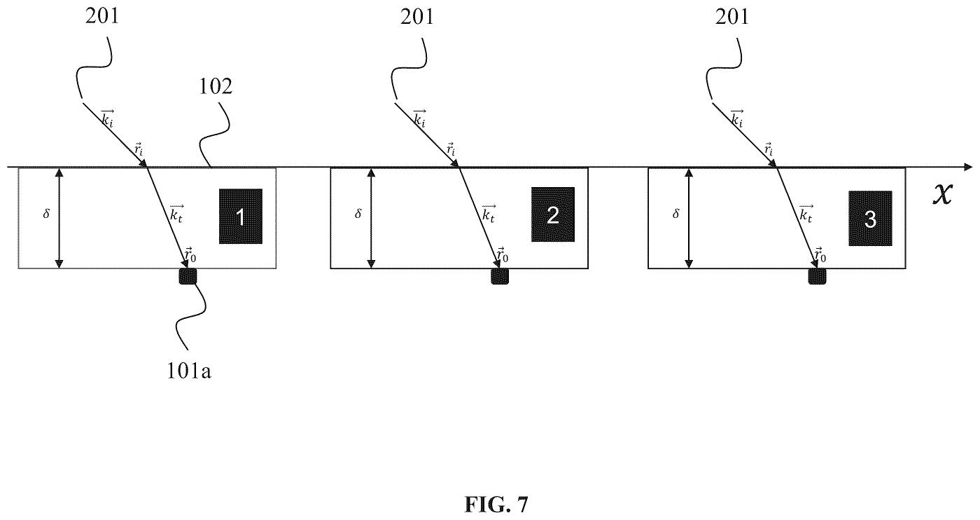

The approach of using a temporal array antenna may be combined with a conventional uniform linear array of antennas. For example, FIG. 7 shows an antenna array of one or more antennas 101, wherein each antenna 101a in the antenna array is covered with a layer of a material 102 with a controllable permittivity and/or permeability. In another example, only some antennas in an antenna array may be covered with a layer of a material 102 with a controllable permittivity and/or permeability while the other antennas in the antenna array may be conventional antennas and not covered by a material 102 with a controllable permittivity and/or permeability.

All antennas of the one or more antennas 101 in an antenna array may be covered by the same material 102 with the same thickness and receive the same control signals. For an array including P elements or antennas, super-resolution algorithms for uniform linear arrays (ULA), and for temporal arrays (TA) may be extended to support a uniform linear temporal array (ULTA) by replacing the calculation of the steering vector for angle θ as follows:

$${a}_{ULTA} ( θ ) = [ \begin{matrix}{a}_{1} ( θ ) \\ ⋮ \\ {a}_{P} ( θ )\end{matrix} ] \qquad ( 6 )$$

Where aₗ(θ) is a steering vector of the l^{th} element, which is based on the corresponding change of the material 102, for example the refractive index of the material 102, covering this element.

An ULTA may be formed by two or more antennas 101 covered with a controllable material 102 forming an equidistant antenna array.

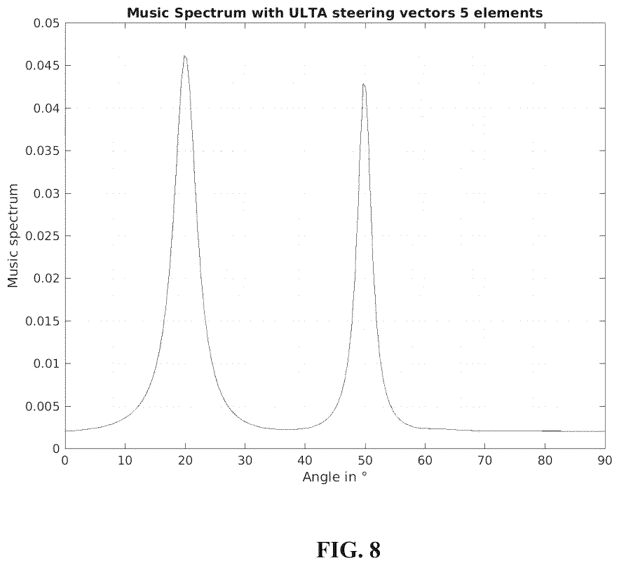

Based on the formulation for the steering vector according to Eq. 6, the MUSIC spectrum can be calculated with conventional ULA related algorithms. FIG. 8 shows an example of a ULTA receiving two input signals 201 at 20° and 50° with respect to its normal vector, wherein the peaks correspond to the estimated angles of arrival 202.

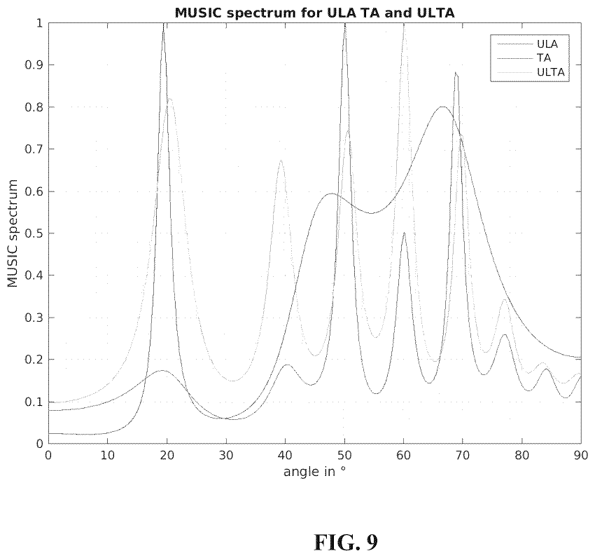

FIG. 9 shows the advantages of temporal arrays and uniform linear temporal arrays compared to conventional uniform linear arrays. FIG. 9 shows a MUSIC spectrum based on an example that includes 5 antenna elements and 5 input signals 201 that are impinging the antennas at 20°, 40°, 50°, 60° and 70°. The MUSIC spectrum of an ULA with 5 elements is unable to recover these angles of arrival 202, while a single antenna 101a TA with 10 time measurements, recovers all of the angles of arrival 202. A ULTA also recovers all of the angles of arrival 202 and additionally has narrower peaks.

Thus, the AoA estimation may be more efficient and/or more accurate.

The embodiments of this disclosure combines some or all of the following benefits:
The requirement for the number of different antennas at the RX 100 side may be reduced;
The requirement for the number of bulky RF chains may be reduced;
The power consumption at the receiver side may be significantly reduced;
Thanks to super-resolution algorithms (MUSIC, ESPRIT . . . ) and the controllable materials, multi-source detection can be performed;
The channel estimation complexity may be reduced at the RX 100 side;
The receiver 100, which may be confined to a limited space, is scalable to an arbitrary number of sources.

The controller 103 may be a processor 103.

Generally, the processor 103 may be configured to perform, conduct or initiate the various operations of the receiver 100 described herein. The processor 103 may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The receiver 100 may further comprise memory circuitry, which stores one or more instruction(s) that can be executed by the processor 103, for example, under control of the software. For instance, the memory circuitry may comprise a non-transitory storage medium storing executable software code which, when executed by the processor 103, causes the various operations of the receiver 100 to be performed. In one embodiment, the receiver 100 may comprises one or more processors 103 and a non-transitory memory connected to the one or more processors 103. The non-transitory memory may carry executable program code which, when executed by the one or more processors 103, causes the receiver 100 to perform, conduct or initiate the operations or methods described herein.

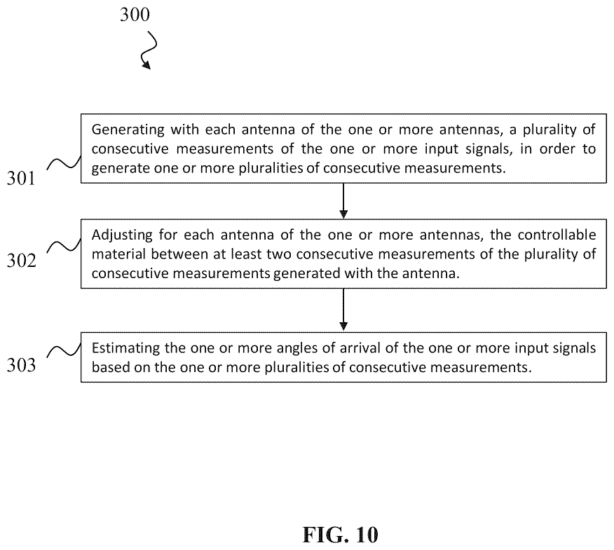

FIG. 10 shows a method 300 according to an embodiment of this disclosure. The method 300 may be performed by the receiver 100. The method 300 comprises a step 301 of generating with each antenna 101a of the one or more antennas 101, a plurality of consecutive measurements 104a of the one or more input signals 201, in order to generate one or more pluralities of consecutive measurements 104. Further, the method 300 comprises a step 302 of adjusting for each antenna 101a of the one or more antennas 101, the controllable material 202 between at least two consecutive measurements of the plurality of consecutive measurements 104a generated with the antenna 101a. Further, the method 300 comprises a step 303 of estimating the one or more angles of arrival 202 of the one or more input signals 201 based on the one or more pluralities of consecutive measurements 104.

In another embodiment, a computer program product comprising a program code for performing a method when the program code is executed on a computer or controller, wherein the computer/controller is configured to operate the receiver 100 for estimating one or more angles of arrival of respectively one or more input signals, wherein the receiver includes one or more antennas, wherein each antenna is covered by a material with a controllable permittivity and/or permeability, and wherein the method comprises: generating, by the controller, with each antenna of the one or more antennas, a plurality of consecutive measurements of the one or more input signals, in order to generate one or more pluralities of consecutive measurements; adjusting, by the controller, for each antenna of the one or more antennas, the controllable material between at least two consecutive measurements of the plurality of consecutive measurements generated with the antenna; and estimating, by the controller, the one or more angles of arrival of the one or more input signals based on the one or more pluralities of consecutive measurements.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A receiver for estimating one or more angles of arrival of respectively one or more input signals, the receiver comprising:
one or more antennas, wherein each antenna is covered by a material with a controllable permittivity and/or permeability; and
a controller configured to:
generate, with each antenna of the one or more antennas, a plurality of consecutive measurements of the one or more input signals, in order to generate one or more pluralities of consecutive measurements;
adjust, for each antenna of the one or more antennas, the controllable material between at least two consecutive measurements of the plurality of consecutive measurements generated with the antenna; and
estimate the one or more angles of arrival of the one or more input signals based on the one or more pluralities of consecutive measurements.

2. The receiver according to claim 1, wherein the controller is further configured to adjust, for each antenna of the one or more antennas, a refractive index of the controllable material between at least two consecutive measurements of the plurality of measurements generated with the antenna.

3. The receiver according to claim 1, wherein the one or more antennas are configured to form an antenna array, and/or
wherein the receiver further comprises one or more additional antennas, and wherein the one or more antennas and the one or more additional antennas are configured to form an antenna array.

4. The receiver according to claim 1, wherein the receiver further comprises a memory, and wherein, for each measurement of the one or more pluralities of consecutive measurements, the memory is configured to:
store the measurement; and
store a refractive index value of the controllable material with which the measurement is generated.

5. The receiver according to claim 4, wherein the controller is further configured to estimate the one or more angles of arrival of the one or more input signals based on a plurality of stored refractive index values and measurements.

6. The receiver according to claim 1, wherein each measurement of the one or more pluralities of consecutive measurements comprises a phase measurement of the one or more input signals.

7. The receiver according to claim 6, wherein the controller is further configured to calculate at least one phase difference based on at least two phase measurements or based on at least one phase measurement and a predetermined reference phase.

8. The receiver according to claim 7, wherein the controller is further configured to estimate the one or more angles of arrival of the one or more input signals based further on the at least one phase difference.

9. The receiver according to claim 8, wherein the controller is further configured to estimate the one or more angles of arrival of the one or more input signals based further on the at least one phase difference and the corresponding stored refractive index value of each measurement of the one or more pluralities of consecutive measurements used for calculating the at least one phase difference.

10. The receiver according to claim 7, wherein each plurality of consecutive measurements of the one or more pluralities of consecutive measurements comprises three or more consecutive measurements, wherein the at least one phase difference comprises at least two phase differences, and wherein the controller is further configured to:
calculate, for each of the one or more input signals, a ratio of two phase differences of the at least two phase differences to form one or more ratios of phase differences, and
estimate the one or more angles of arrival of the one or more input signals based further on the one or more ratios of phase differences.

11. The receiver according to claim 10, wherein the controller is further configured to calculate the two phase differences of each ratio of the one or more ratios of phase differences based on at least one different phase measurement.

12. The receiver according to claim 1, wherein the controller is further configured to estimate the one or more angles of arrival of the one or more input signals based further on a thickness of the controllable material covering each antenna of the one or more antennas and a norm of a wave vector of each of the one or more input signals.

13. The receiver according to claim 1, wherein the controller is further configured to estimate the one or more angles of arrival of the one or more input signals based further on a refractive index of an ambient material.

14. The receiver according to claim 1, wherein the controller is further configured to:
average a plurality of measurements to form one or more averaged measurements, and
estimate the one or more angles of arrival of the one or more input signals based further on the one or more averaged measurements.

15. The receiver according to claim 1, wherein the controller is further configured to estimate the one or more angles of arrival of the one or more input signals based further on a predetermined lookup table comprising at least one of differential phases and ratios of differential phases.

16. The receiver according to claim 1, wherein the number of measurements of the one or more pluralities of consecutive measurements is larger than the number of the one or more input signals.

17. The receiver according to claim 1, wherein each antenna of the one or more antennas is covered with the same controllable material of a same thickness, or wherein at least two antennas of the one or more antennas are covered with at least one of a different controllable material and a controllable material of different thickness.

18. The receiver according to claim 1, wherein the controller is further configured to estimate the one or more angles of arrival of the one or more input signals by using at least one of a multiple signal classification algorithm, an estimation of signal parameters via rotational invariant techniques algorithm, and a super-resolution algorithm for an uniform linear and temporal array.

19. The receiver according to claim 2, wherein the controller is further configured to:
generate an overall matrix of steering vectors, wherein the overall matrix of steering vectors comprises a matrix of steering vectors for each input signal of the one or more input signals, and wherein the matrix of steering vectors comprises a steering vector for each measurement of the corresponding input signal; and
estimate the one or more angles of arrival of the one or more input signals based further on at least one of the overall matrix of steering vectors and multiplying the overall matrix of steering vectors with a matrix of input signals of the one more input signals or a matrix derived from empirical statistics of the one or more input signals.

20. A method of operating a receiver for estimating one or more angles of arrival of respectively one or more input signals, the receiver comprising one or more antennas, wherein each antenna is covered by a material with a controllable permittivity and/or permeability, and a controller, wherein the method comprises:
generating, by the controller, with each antenna of the one or more antennas, a plurality of consecutive measurements of the one or more input signals, in order to generate one or more pluralities of consecutive measurements;
adjusting, by the controller, for each antenna of the one or more antennas, the controllable material between at least two consecutive measurements of the plurality of consecutive measurements generated with the antenna; and
estimating, by the controller, the one or more angles of arrival of the one or more input signals based on the one or more pluralities of consecutive measurements.
